(19) United States
(12) Patent Application Publication
(10) Pub. No.: US 2018/0284517 A1
(43) Pub. Date: Oct. 4, 2018

(54) DISPLAY PANEL AND DISPLAY DEVICE

(71) Applicant: XIAMEN TIANMA MICRO-ELECTRONICS CO., LTD., XIAMEN (CN)

(72) Inventors: Ling WU, XIAMEN (CN); Huangyao WU, XIAMEN (CN); Hongbo ZHOU, XIAMEN (CN)

(73) Assignee: XIAMEN TIANMA MICRO-ELECTRONICS CO., LTD., XIAMEN (CN)

(21) Appl. No.: 15/995,133

(22) Filed: Jun. 1, 2018

(30) Foreign Application Priority Data
Jan. 30, 2018 (CN) 201810089713.8

(51) Int. Cl. G02F 1/1339; G02F 1/1341; G02F 1/1335

(52) U.S. Cl. CPC G02F 1/13394; G02F 1/1341; G02F 2001/13396; G02F 1/133512; G02F 1/133514

(57) ABSTRACT

A display panel and a display device are provided, and the display panel includes first and second substrates disposed oppositely, an insulating layer having multiple holes and multiple main spacers are disposed on a side of the first substrate facing the second substrate and on a side of the second substrate facing the first substrate respectively, first protrusions are disposed at positions on the insulating layer facing corresponding second substrate, each first protrusion includes first filling portions in at least two holes and a first covering portion connected to first filling portions, in a plane of the substrate, a vertical projection of first filling portions intersects with that of the first covering portion, an end of each main spacer contacts respective one first protrusion. Improvements to maintaining the effect of the spacer with respect to the box thickness of the display panel and alleviates squeezing problem.

### CROSS-REFERENCE TO RELATED APPLICATIONS

The present application claims priority to Chinese Patent Application No. 201810089713.8, filed on Jan. 30, 2018, the content of which is incorporated herein by reference in its entirety.

### TECHNICAL FIELD

The present disclosure relates to the field of display technologies and, in particular, to a display panel and a display device.

### BACKGROUND

At present, a commonly used display panel is a liquid crystal display panel. The liquid crystal display panel generally includes an array substrate, a color film substrate disposed opposite to the array substrate, and liquid crystal filled between the array substrate and the color film substrate. In order to maintain the spacing between the array substrate and the color film substrate, i.e., the box thickness of the display panel, the liquid crystal display panel further includes a spacer disposed between the array substrate and the color film substrate. The spacer is usually disposed on the color film substrate, and the top of the spacer is in contact with the array substrate.

The inventor of the present disclosure found that the contact area between the top of the spacer and the array substrate in the related art is relatively small, and along a direction parallel to the array substrate, the top of the spacer is prone to slide into the aperture region of the array substrate (i.e., the light-transparent region of the array substrate) when the color film substrate and the array substrate are displaced relative to each other, which not only makes the spacer less effective for maintaining the box thickness, but also causes a squeezing problem.

### SUMMARY

The present disclosure provides a display panel and a display device, which are used to improve the poor maintaining effect of the spacer with respect to the box thickness of the display panel and alleviate the squeezing problem.

In one embodiment, the present disclosure provides a display panel, and the display panel includes a first substrate and a second substrate oppositely disposed with respect to each other, and an insulating layer is disposed on a side of the first substrate facing the second substrate, and the insulating layer has holes therein, main spacers are disposed on a surface of the second substrate facing the first substrate, first protrusions are further disposed at positions on one surface of the insulating layer facing the second substrate corresponding to the plurality of main spacers, the plurality of first protrusions each includes first filling portions filled in at least two of the plurality of holes and a first covering portion connected to the first filling portions, in a plane where the substrate is located, an arrangement direction of a vertical projection of the first filling portions intersects with an extending direction of a vertical projection of the first covering portion, and an end of each of the plurality of main spacers is in contact with a respective one of the plurality of first protrusions.

In one embodiment, the present disclosure provides a display device, and the display device includes the above-described display panel.

In the display panel and display device described above, main spacers are provided on the second substrate, and first protrusions are provided on a side of the insulating layer in the first substrate facing the second substrate, an end of the main spacer is in contact with the first protrusion. The first protrusions each include first filling portions filled in at least two holes and a first covering portion connected to the first filling portions, in the plane where the first substrate is located, an arrangement direction of a vertical projection of the first filling portions intersects with an extending direction of a vertical projection of the first covering portion, so that the area of the first protrusion is relatively large, and the contact area of the main spacer with the first protrusion is relatively large, in a direction parallel to the first substrate (for example, the arrangement direction of the vertical projection of the first filling portions, and the extending direction of the vertical projection of the first covering portion), when the second substrate and the first substrate are relatively displaced, one end of the main spacer can still be contact with the first protrusion, and it is not easy to enter the aperture region of the first substrate (i.e., the light-transparent region of the first substrate), which can not only improve the maintaining effect of the main spacer with respect to the box thickness of the display panel, but also alleviate or even avoid the squeezing problem caused by the slipping of main spacer.

### BRIEF DESCRIPTION OF DRAWINGS

In order to more clearly illustrate embodiments of the present disclosure, the accompanying drawings used in the embodiments and in the related art are briefly introduced as follows.

FIG. 1 is a schematic cross-sectional view of a display panel according to an embodiment of the present disclosure;

FIG. 2 is top view I of a first substrate according to an embodiment of the present disclosure;

FIG. 3 is top view I of a second substrate according to an embodiment of the present disclosure;

FIG. 4 is a schematic cross-sectional view of a display panel along A-A′ direction in FIG. 2 according to an embodiment of the present disclosure;

FIG. 5 is top view I of a first protrusion according to an embodiment of the present disclosure;

FIG. 6 is top view II of a first protrusion according to an embodiment of the present disclosure;

FIG. 7 is top view III of a first protrusion according to an embodiment of the present disclosure;

FIG. 8 is a schematic diagram of a position relationship between a first protrusion and a main spacer according to an embodiment of the present disclosure;

FIG. 9 is top view II of a first substrate according to an embodiment of the present disclosure;

FIG. 10 is schematic cross-sectional view I of FIG. 9 along B-B′ direction according to an embodiment of the present disclosure;

FIG. 11 is top view III of a first substrate according to an embodiment of the present disclosure;

FIG. 12 is a schematic diagram of a force sensor according to an embodiment of the present disclosure;

FIG. 13 is schematic cross-sectional view II of FIG. 9 along B-B′ direction according to an embodiment of the present disclosure;

FIG. 14 is top view II of a second substrate according to an embodiment of the present disclosure;

FIG. 15 is top view III of a second substrate according to an embodiment of the present disclosure;

FIG. 16 is top view IV of a second substrate according to an embodiment of the present disclosure;

FIG. 17 is top view V of a second substrate according to an embodiment of the present disclosure;

FIG. 18 is a schematic diagram of a position relationship between a second protrusion and an auxiliary spacer according to an embodiment of the present disclosure;

FIG. 19 is a schematic diagram of a main spacer and a liquid crystal arrangement according to an embodiment of the present disclosure; and

FIG. 20 is a schematic diagram of a display device according to an embodiment of the present disclosure.

### DESCRIPTION OF EMBODIMENTS

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that, although the substrate may be described using the terms of “first”, “second”, etc., in the embodiments of the present disclosure, the substrate will not be limited to these terms. These terms are merely used to distinguish substrates from one another. For example, without departing from the scope of the embodiments of the present disclosure, a first substrate may also be referred to as a second substrate, similarly, a second substrate may also be referred to as a first substrate, similarly, the terms of “first”, “second”, etc., are also applicable in the same way for the description with respect to the protrusion, sub-pixel, pixel unit, color resistance, and the like.

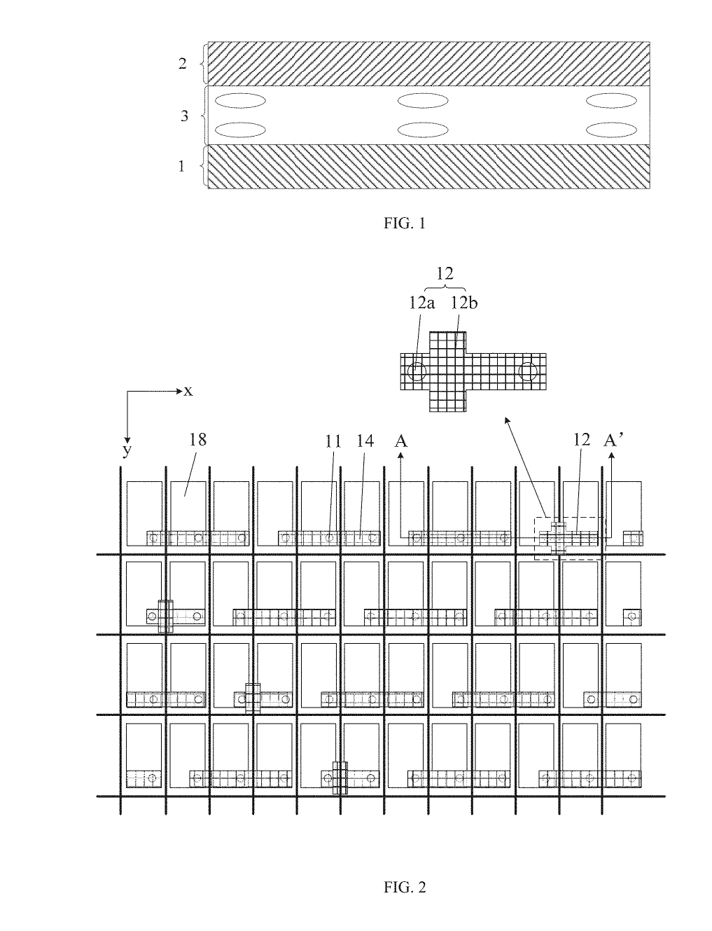

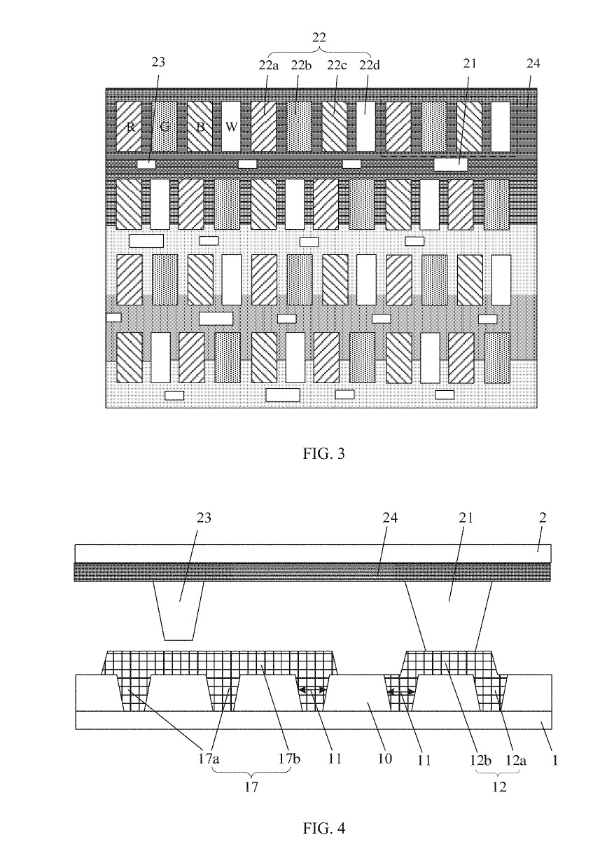

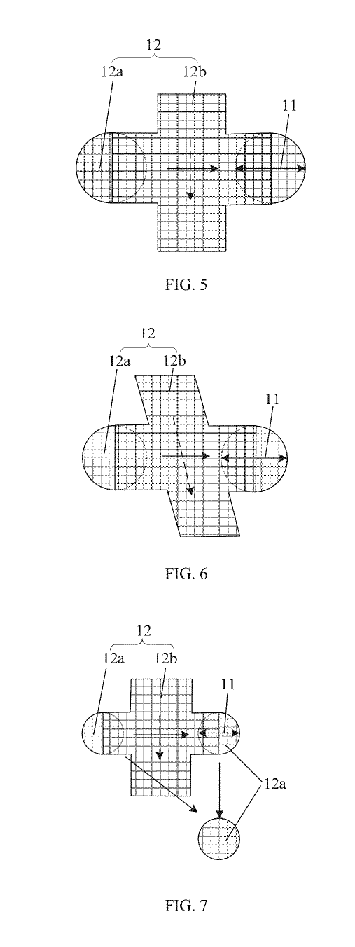

The present disclosure provides a display panel, as shown in FIG. 1, which is a schematic cross-sectional view of a display panel according to an embodiment of the present disclosure. The display panel includes a first substrate 1 and a second substrate 2 disposed opposite to each other. In one embodiment, as shown in FIG. 1, the display panel is a liquid crystal display panel. The display panel further includes a liquid crystal molecular layer 3 located between the first substrate 1 and the second substrate 2. As shown in FIG. 2. FIG. 3 and FIG. 4 (in FIG. 2, for illustrating a position relationship between a hole 11 and a first protrusion 12, the insulating layer is not shown), FIG. 2 is top view I of a first substrate according to an embodiment of the present disclosure, FIG. 3 is top view I of a second substrate according to an embodiment of the present disclosure, and FIG. 4 is a schematic cross-sectional view of a display panel along A′ direction in FIG. 2 according to an embodiment of the present disclosure. An insulating layer 10 is provided on a side of the first substrate 1 facing the second substrate 2, and the insulating layer 10 has holes 11. Main spacers 21 is provided on a side of the second substrate 2 facing the first substrate 1, first protrusions 12 is provided on a side of the insulating layer 10 facing the second substrate and is located at positions corresponding to positions of the plurality of main spacers 21. The plurality of first protrusions 12 each includes first filling portions 12a filled in at least two holes 11 and a first covering portion 12b connected to the first filling portions 12a, as shown in FIGS. 5-7. FIGS. 5-7 are top views I-III of a first protrusion according to an embodiment of the present disclosure. In a plane where the first substrate 1 is located, an arrangement direction of vertical projections of the first filling portions 12a intersects with an extending direction of a vertical projection of the first covering portion 12b, one end of the main spacer 21 being in contact with the first protrusion 12.

It should be understood that the first substrate 1 included in the display panel has an aperture region, i.e., a light-transparent region in a display region of the first substrate 1. The first protrusion 12 disposed on the first substrate 1 should be located in a non-aperture region, so that it will not deteriorate normal displaying of the display panel.

The extending direction of the vertical projection of the first covering portion 12b refers to a lengthwise extending direction of the vertical projection of the first covering portion 12b, and the arrangement direction of the vertical projections of the first filling portions 12a refers to an arrangement direction of the vertical projections of the first filling portions 12a filled in any two holes 11. As shown in FIG. 5 and FIG. 6, the first filling portions 12a included in the first filling 12 only correspond to at least two holes 11 (two holes 11 shown in FIG. 5 and FIG. 6 as an example) located in a same straight line, and thus the arrangement direction (shown by an unidirectional arrow in a solid line in FIG. 5 and FIG. 6) is unique, and the arrangement direction intersects with and is perpendicular to the extending direction (shown by an unidirectional arrow in a dashed line in FIG. 5) of the vertical projection of the first covering portion 12b in FIG. 5, while the arrangement direction intersects with but is not perpendicular to the extending direction (shown by an unidirectional arrow in a dashed line in FIG. 6) of the vertical projection of the first covering portion 12b in FIG. 6. As shown in FIG. 7, the first filling portions 12a included in the first protrusion 12 corresponds to two or more holes 11 (three holes 11 shown in FIG. 7 as an example) which are not located in a same straight line, and thus the arrangement direction (shown by an unidirectional arrow in a solid line in FIG. 7) is not unique, as long as at least one arrangement direction intersects with the extending direction (shown by an unidirectional arrow in a dashed line in FIG. 7) of the vertical projection of the first covering portion 12b.

It should be noted that, not all of the first protrusions 12 may have a same connecting manner and position relationship as described above with respect to the first connection portion 12a and the first covering portion 12b, and selections may be made according to actual requirements. In addition, there is no limitation on whether the insulating layer 10 is a single-layer structure or a multi-layer structure, and selections may be made according to actual requirements. The structure of the insulating layer 10 will be described in the following in the embodiments of the present disclosure in combination with the possible structure of the first substrate 1.

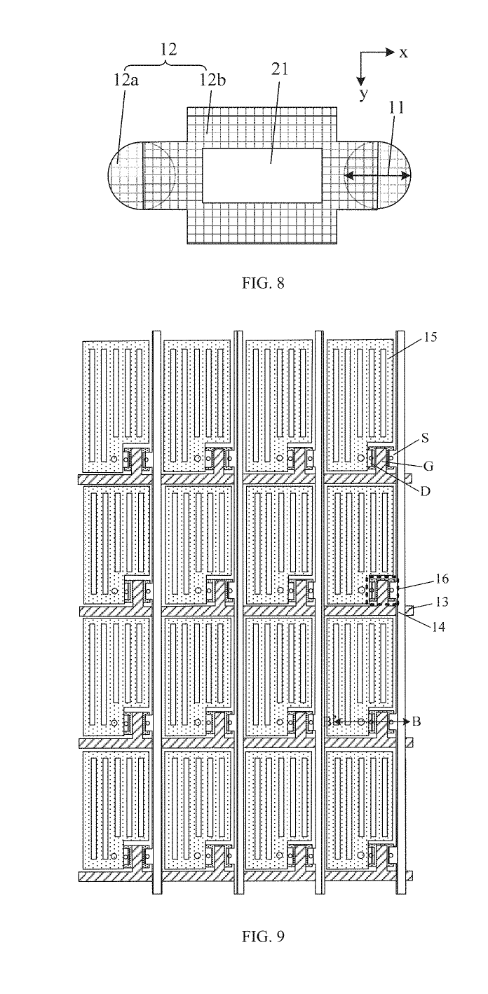

In the display panel described above, main spacers 21 are provided on the second substrate 2, first protrusions 12 are provided on a side of the first substrate 1 facing the second substrate 2 and located at positions corresponding to those of the main spacers 21, and an end of the main spacer 12 is in contact with the first protrusion 12. The first protrusions 12 each include first filling portions 12a filled in at least two holes 11 and a first covering portion 12b connected to the first filling portions 12a, therefore, in the plane where the first substrate 1 is located, an arrangement direction of vertical projections of the first filling portions 12a intersects with an extending direction of a vertical projection of the first covering portion 12b, so that the area of the first protrusion 12 is relatively large, and the contact area of the main spacer 21 with the first protrusion 12 is relatively large. In a direction parallel to the first substrate 1 (for example, the arrangement direction of the vertical projections of the first filling portions 12a, and the extending direction of the vertical projection of the first covering portion 12b), when the second substrate 2 and the first substrate 1 are relatively displaced, one end of the main spacer 21 can still be contact with the first protrusion 12, and it is not easy to enter the aperture region of the first substrate 1, which can not only improve the maintaining effect of the main spacer with respect to the box thickness of the display panel, but also alleviate or even avoid the squeezing problem caused by the slipping of main spacer 21. As shown in FIG. 8, FIG. 8 is a schematic diagram of a position relationship between a first protrusion and a main spacer according to an embodiment of the present disclosure. When one end of the main spacer 21 is in contact with the middle portion of the first protrusion 12, the contact area between the main spacer 21 and the first protrusion 12 becomes maximum, and in the arrangement direction of the vertical projections of the first filling portions 12a and the extending direction of the vertical projection of the first covering portion 12b, there is a certain distance between the main spacer 21 and the edge of the first protrusion 12, and the above beneficial effect becomes more significant.

Exemplarily, the first substrate 1 is an array substrate. As shown in FIG. 9, FIG. 9 is top view II of a first substrate according to an embodiment of the present disclosure. In this embodiment, grid lines 13 and data lines 14 are provided on the first substrate 1 in a crisscross manner. The plurality of gate lines 13 and the plurality of data lines 14 define sub-pixels. Each sub-pixel is provided with a pixel electrode 15 and a thin film transistor 16. A source electrode S of the thin film transistor 16 is electrically connected to the data line 14, a drain electrode D is electrically connected to the pixel electrode 15, and a gate electrode G is electrically connected to the gate line 13.

The first substrate 1 in the embodiments of the present disclosure may further include a common electrode, a touch electrode line, and the like, which are not shown in FIG. 9, and selections may be made according to actual requirements.

When the top view of the first substrate 1 is as shown in FIG. 9, there may be cross-sectional views. The embodiments of the present disclosure will describe it in the following by taking examples.

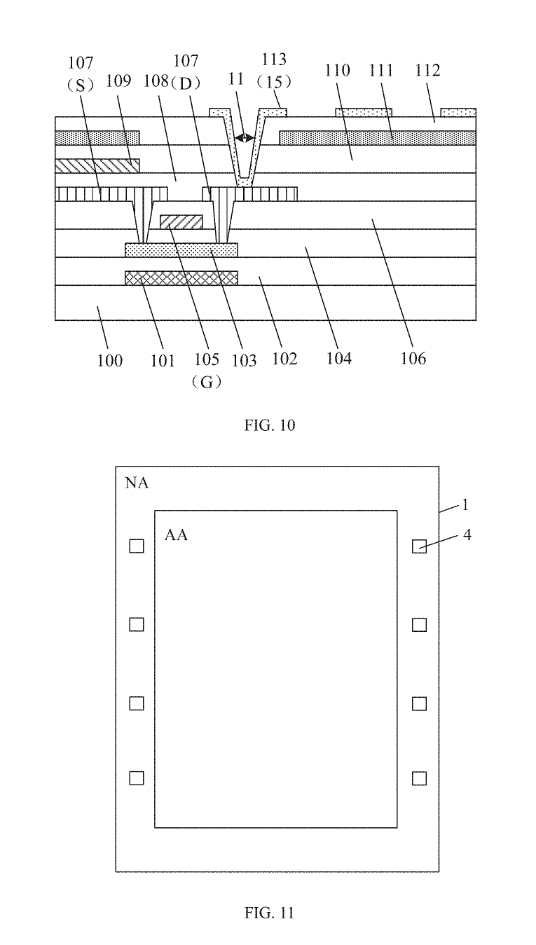

In a first example, as shown in FIG. 10, FIG. 10 is schematic cross-sectional view I of FIG. 9 along B-B′ direction according to an embodiment of the present disclosure. Along a direction away from a base substrate 100, there are a light shielding layer 101, a buffer layer 102, a polysilicon layer 103, a gate insulating layer 104, a gate metal layer 105, an interlayer insulating layer 106, a source-drain metal layer 107, a planarization layer 108, a touch leading wire layer 109, a first passivation layer 110, a common electrode layer 111, a second passivation layer 112 and a pixel electrode layer 113 sequentially provided on the first substrate 1.

The polysilicon layer 103 includes an active layer of the thin film transistor 16, the gate metal layer 105 includes a gate electrode G of the thin film transistor 16 and a gate line 13, and the source-drain metal layer 107 includes the source electrode S and the drain electrode D of the thin film transistor 16, and a data line 14. The source electrode S and drain electrode D are connected to the active layer respectively via a through hole passing through the interlayer insulating layer 106 and the gate insulating layer 104. The common electrode layer 111 includes common electrode blocks, and each common electrode block is multiplexed as a touch electrode. The touch leading wire layer 109 includes touch leading wires for providing a touch signal to each common electrode block, and it is electrically connected to the common electrode block via a though hole passing through the first passivation layer 110. The pixel electrode layer 113 includes pixel electrodes 15, and each pixel electrode 15 is electrically connected to the drain electrode D of the thin film transistor 16 via a through hole passing through the second passivation layer 112, the first passivation layer 110, and the planarization layer 108.

Based on the first substrate having the above structure, the above-mentioned “insulating layer 10” in the embodiments of the present disclosure may include a three-layer structure, including a second passivation layer 112, a first passivation layer 110, and a planarization layer 108. Correspondingly, the hole 11 may be a hole formed after the pixel electrode layer is deposited in the though hole for electrically connecting the pixel electrode 15 with the drain electrode D.

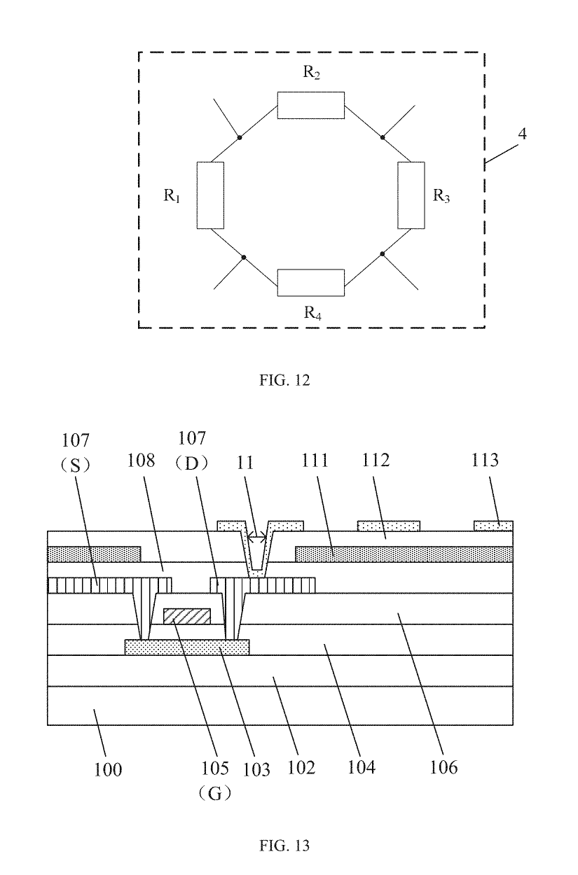

In another embodiment, as shown in FIG. 11, FIG. 11 is top view III of a first substrate according to an embodiment of the present disclosure. The first substrate 1 having the above structure includes a display region AA and a peripheral region NA surrounding the display region AA. When the force sensor 4 is disposed in the peripheral region NA, for example, the force sensor 4 is a resistance type force sensor, as shown in FIG. 12, which is a schematic diagram of a force sensor according to an embodiment of the present disclosure, the force sensor 4 includes a first resistor R1, a second resistor R2, a third resistor R3, and a fourth resistor R4 that are electrically connected in sequence, and leading wires that are electrically connected to the respective resistors. The first resistor R1, the second resistor R2, the third resistor R3, and the fourth resistor R4 may be formed in a same film layer as the common electrode layer 111. The leading wires electrically connected to the first resistor R1, the second resistor R2, the third resistor R3, and the fourth resistor R4 may be formed in a same film layer as the touch leading wire layer 109. Then the insulating layer 10 in the embodiments of the present disclosure may be a first passivation layer 110, the hole 11 may be a hole formed after the touch leading wire layer 109 (i.e., the film layer where the leading wire is located) is deposited in the though hole for electrically connecting the leading wire to each resistor.

It should be noted that, as for the first substrate 1, in order to make the contact resistance between the source electrode S and the drain electrode D of the thin film transistor 16 and the active layer to be smaller, the region outside the channel region of the active layer may be performed with high concentration doping, so as to form two ohmic contact regions. The two ohmic contact regions are respectively connected to the source electrode S and the drain electrode D of the thin film transistor 16. The vertical projection of the light shielding layer 101 on the base substrate 100 covers the vertical projection of the active layer on the base substrate 100, so that the light emitted from the base substrate 100 toward the active layer can be shielded, thereby avoiding that electrical properties of the active layer are deteriorated by the light, so that the thin film transistor 16 can get better electrical properties. The material of the above-mentioned buffer layer 102 may be an insulating material such as silicon oxide, carbon fluoride, or the like. The buffer layer 102 may separate the base substrate 100 (e.g., a glass substrate or other material substrate) from the active layer on the base substrate 100, so as to prevent the active layer from being contaminated by direct contact with the base substrate 100 and the light shielding layer 101. In addition, the active layer of the thin film transistor 16 is disposed on the buffer layer 102, so that the hole injection efficiency of the thin film transistor 16 can be improved, and thus the driving voltage of each thin film transistor 16 can be decreased, and the performance of the thin film transistor 16 can be improved.

In a second example, as shown in FIG. 13, FIG. 13 is schematic cross-sectional view II of FIG. 9 along B-B′ direction according to an embodiment of the present disclosure. Along a direction away from a base substrate 100, there are a buffer layer 102, a polysilicon layer 103, a gate insulating layer 104, a gate metal layer 105, an interlayer insulating layer 106, a source-drain metal layer 107, a planarization layer 108, a common electrode layer 111, a second passivation layer 112 and a pixel electrode layer 113 sequentially provided on the first substrate 1.

The polysilicon layer 103 includes the active layer of the thin film transistor 16, the gate metal layer 105 includes the gate electrode G of the thin film transistor 16 and the gate line 13, and the source-drain metal layer 107 includes the source electrode S and the drain electrode D of the thin film transistor 16, and the data line 14. The source electrode S and drain electrode D are connected to the active layer respectively via a through hole passing through the interlayer insulating layer 106 and the gate insulating layer 104. The pixel electrode layer 113 includes pixel electrodes 15, and each pixel electrode 15 is electrically connected to the drain electrode D of the thin film transistor 16 via a through hole passing through the second passivation layer 112 and the planarization layer 108.

Based on the first substrate 1 having the above structure, the above-mentioned “insulating layer 10” in the embodiments of the present disclosure may include a double-layer structure, including a second passivation layer 112 and a planarization layer 108. Correspondingly, the hole 11 in the embodiments of the present disclosure may be a hole formed after the pixel electrode layer is deposited in the though hole for electrically connecting the pixel electrode 15 with the drain electrode D.

The first substrate 1 having this structure may also be provided with an ohmic contact region and a light shielding layer. As for the specific setting manner, reference may be made to the related description in the first example, and as for the buffer layer 102, reference may also be made to the related description in the first example, which will not be repeated herein.

In addition, it can be seen from the above description that the arrangement direction of the vertical projections of the first filling portions 12a in the plane where the first substrate 1 is located, may intersect with the extending direction of the vertical projection of the first covering portion 12b in various manners. For example, the two intersect with each other but are not perpendicular to each other, or the two intersect with each other and are perpendicular to each other. The case in which the two intersect with each other and are perpendicular to each other will be described in the following embodiments of the present disclosure as an example.

Exemplarily, as shown in FIG. 5, each first protrusion 12 includes two first filling portions 12a filled in two holes 11, and the arrangement direction of vertical projections of the two first filling portions 12a in the plane where the first substrate 1 is located, is perpendicular to the extending direction of a vertical projection of the first covering portion 12b. On this Basis, in the embodiments of the present disclosure, the first substrate 1 and the second substrate 2 having a specific structure will be taken as an example so as to describe the arrangement direction of the vertical projections of the two first filling portions 12a in the plane where the first substrate 1 is located and the extending direction of the vertical projection of the first covering portion 12b.

In one embodiment, as shown in FIG. 2 and FIG. 3, the first substrate 1 includes sub-pixels 18 arranged in an array, the second substrate 2 includes color resistances 22 arranged in an array, the plurality of sub-pixels 18 is in one-to-one correspondence with the plurality of color resistances 22. In the plane where the first substrate 1 is located, the arrangement direction of the vertical projections of the two first filling portions 12a and the extending direction of the vertical projection of the first covering portion 12b are respectively a row direction x and a column direction y of the sub-pixels 18, that is, the arrangement direction of the vertical projections of the two first filling portions 12a is the row direction x of the sub-pixels 18, and the extending direction of the vertical projection of the first covering portion 12b is the column direction y of the sub-pixels 18, in another embodiment, the arrangement direction of the vertical projections of the two first filling portions 12a may be the column direction v of the sub-pixels 18, and the extending direction of the vertical projection of the first covering portion 12b is the row direction x of the sub-pixels 18. In this case, the first protrusion 12 may be disposed among adjacent four sub-pixels 18, which is advantageous for the first protrusion 12 to have a larger size in both the arrangement direction and the extension direction, without deteriorating the normal displaying of the sub-pixel 18.

In one embodiment, as shown in FIG. 2, in the plane where the first substrate 1 is located, the arrangement direction of the vertical projections of the two first filling portions 12a is the row direction x of the sub-pixels 18, and the extending direction of the vertical projection of the first covering portion 12b is the column direction y of the sub-pixels 18.

An end of the main spacer 21 being in contact with the first substrate 1 may choose a variety of shapes, for example, a rectangle, a square, a circle, or the like. In one embodiment, as shown in FIG. 3 and FIG. 8, in the plane where the first substrate 1 is located, the vertical projection of the end of the main spacer 21 being in contact with the first protrusion 12 is rectangle-shaped, and an extending direction of its long edge is the row direction x or the column direction y of the sub-pixels 18 (in FIG. 8, taking the extending direction of its long edge as the row direction x of the sub-pixels as an example), that is, the extending direction of its long edge is the same as the arrangement direction of the vertical projections of the two first filling portions 12a included in the first protrusion 12, or the same as the extending direction of the vertical projection of the first covering portion 12b included in the first protrusion 12, so that the shape of the end of the main spacer 21 being in contact with the first protrusion 12 matches the shape of the first protrusion 12. The larger the contact area of the main spacer 21 with the first protrusion 12, the better the maintaining effect of the main spacer 21 with respect to the box thickness.

It should be noted that there may be multiple specific types and arrangements of the plurality of color resistances 22 included in the second substrate 2, which will not be described in the embodiments of the present disclosure with examples.

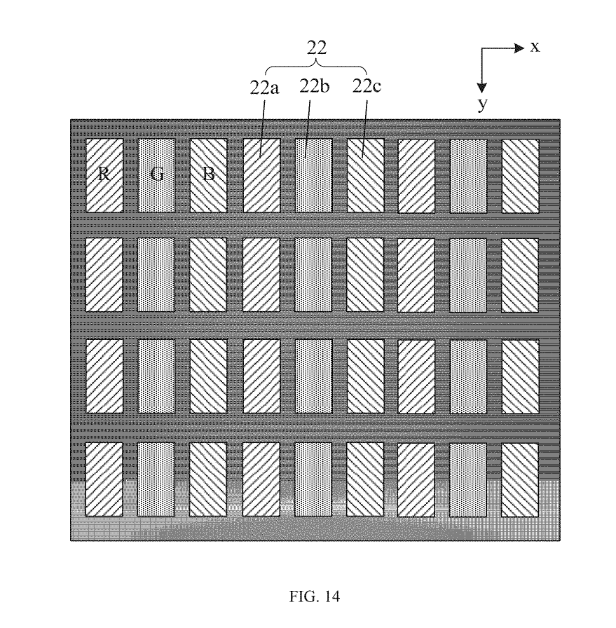

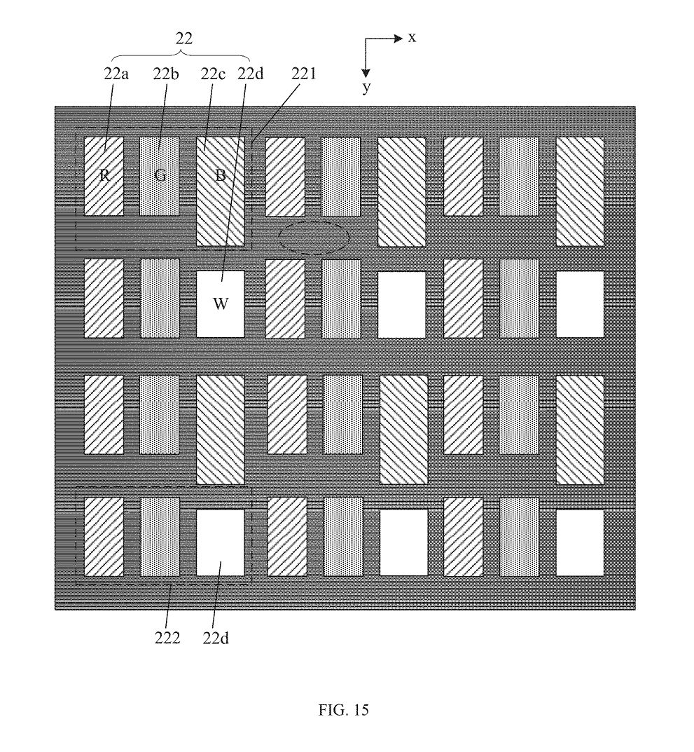

In an example, as shown in FIG. 14, FIG. 14 is top view II of a second substrate according to an embodiment of the present disclosure. The color resistances 22 disposed on the second substrate 2 include a first color resistance 22a, a second color resistance 22b, and a third color resistance 22c. The first color resistance 22a is one of a red color resistance (shown as R in FIG. 12), a green color resistance (shown as G in FIG. 12), and a blue color resistance (shown as B in FIG. 12); the second color resistance 22b is one of the remaining two of the red color resistance, the green color resistance, and the blue color resistance; the third color resistance 22c is the other one of the remaining two of the red color resistance, the green color resistance, and the blue color resistance. For example, in FIG. 12, the first color resistance 22a is a red color resistance R, the second color resistance 22b is a green color resistance G, and the third color resistance 22c is a blue color resistance B. On this Basis, the arrangement of the color resistances 22 may be various. Exemplarily, as shown in FIG. 12, the first color resistance 22a, the second color resistance 22b, and the third color resistance 22c are sequentially arranged along the row direction x of the sub-pixels 18, and the same color resistances are sequentially arranged along the column direction y of the sub-pixels 18.

In another example, as shown in FIG. 3, the color resistances 22 disposed on the second substrate 2 include a first color resistance 22a, a second color resistance 22b, a third color resistance 22c, and a highlight color resistance 22d. In one embodiment, the first color resistance 22a is one of a red color resistance (shown as R in FIG. 3) and a green color resistance (shown as G in FIG. 3), the second color resistance 22b is the other one of the red color resistance (shown as R in FIG. 3) and the green color resistance (shown as G in FIG. 3), the third color resistance 22c is a blue color resistance (shown as B in FIG. 3), and the highlight color resistance 22d is a yellow color resistance or a white color resistance (shown as W in FIG. 3). Exemplarily, as shown in FIG. 3, the first color resistance 22a is a red color resistance R, the second color resistance 22b is a green color resistance G, the third color resistance 22c is a blue color resistance B, and the highlight color resistance 22d is a white color resistance W.

On this Basis, there may be multiple ways for arranging the color resistances 22, which will be described as follows in the embodiments of the present disclosure with examples.

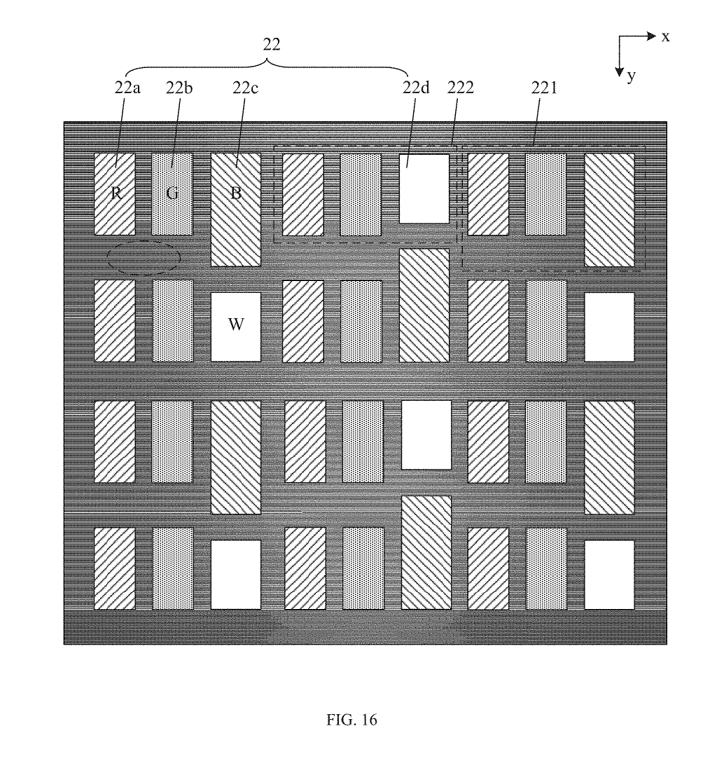

In one embodiment, as shown in FIG. 15, FIG. 15 is top view III of a second substrate according to an embodiment of the present disclosure. The color resistances 22 include multiple first pixel units 221 and multiple second pixel units 222, and the first pixel units 221 and the second pixel units 222 are alternately arranged along the column direction y of the sub-pixels. The first pixel units 221 includes a first color resistance 22a, a second color resistance 22b, and a third color resistance 22c arranged sequentially along the row direction x of the sub-pixels. The second pixel unit 222 includes a first color resistance 22a, a second color resistance 22b, and a highlight color resistance 22d arranged sequentially along the row direction x of the sub-pixels. The area of the third color resistance 22c is larger than the area of the first color resistance 22a, and the area of the highlight color resistance 22d is smaller than the sum of the areas of two first color resistances 22a. As shown in FIG. 15, along the row direction x of the sub-pixels, only the first pixel unit 221 is provided or only the second pixel unit 222 is provided. In one embodiment, as shown in FIG. 16, which is top view IV of a second substrate according to an embodiment of the present disclosure, the first pixel unit 221 and the second pixel unit 222 are sequentially arranged along the row direction x of the sub-pixels, which will not be limited in this embodiment of the present disclosure.

As for the color resistances with such an arrangement manner, during a display process, high brightness can be displayed, besides, a single column of color resistances can display a line having a single color, making the character displaying effect more sharp. For example, as shown in FIG. 15, the first color resistance 22a is a red color resistance R, the second color resistance 22b is a green color resistance G, the third color resistance 22c is a blue color resistance B, and the highlight color resistance 22d is a white color resistance W. The first column of color resistances from the left side in FIG. 5 can display a red line, the second column of color resistances from the left side in FIG. 5 can display a green line, and the third column of color resistances from the left side in FIG. 5 can display a blue line.

In addition, since the area of the third color resistance 22c is larger than the area of the first color resistance 22a, and the area of the highlight color resistance 22d is smaller than the sum of the areas of two first color resistances 22a, the first pixel unit 221 and the second pixel unit 222 are asymmetric to each other. If the spacer still adopts the arrangement manner in the related art, the main spacer 21 will more easily slide into the aperture region of the first substrate 1. Therefore, as for the second substrate 2 having this structure, the arrangement of the first protrusion 12 in the embodiments of the present disclosure will achieve more significant beneficial effects.

In addition, as shown in FIG. 15 and FIG. 16, the positions among adjacent two first color resistances 22a and two second color resistances 22b are relatively regular. Therefore, selectively, it is possible that the vertical projection of the main spacer 21 is located among adjacent two first color resistances 22a and two second color resistances 22b (the elliptic region surrounded by dashed lines in FIG. 15 and FIG. 16) in the plane where the color resistance 22 is located. Between adjacent two first color resistances 22a and two second color resistances 22b, so that a main spacer 21 with a relatively large size can be made, which can improve the maintaining effect of the main spacer with respect to the box thickness.

The inventor of the present disclosure found that in order to achieve the display effect of the display panel, the area of the third color resistance 22c needs to be reasonably selected. In addition, if the area of the highlight color resistance 22d is extremely large, it is prone to appear a display defect with respect to the display panel. For example, when the first color resistance, the second color resistance, the third color resistance, and the highlight color resistance are set in an area ratio of 1:1:1:1, the brightness of the highlight color resistance is extremely high, graininess is prone to appear with respect to the display screen, broken line phenomenon is prone to appear with respect to the display line, when the area of the highlight color resistance 22d is extremely small, the brightness of the display panel is extremely low, neither of which is practical, therefore, it is necessary to reasonably select the area of the third color resistance 22c and the area of the highlighted color resistance 22d. In one embodiment, in an embodiment of the present disclosure, the area of the third color resistance 22c is twice the area of the first color resistance 22a, the area of the highlight color resistance 22d is 50%-60% of the area of two first color resistances 22a. In this case, the brightness of the display panel can be relatively high, which is more suitable for outdoor highlight applications, and it also achieves that the display panel can have a better display effect under the circumstance that the first color resistance 22a, the second color resistance 22b, and the third color resistance 22c have identical brightness on the entire second substrate 2.

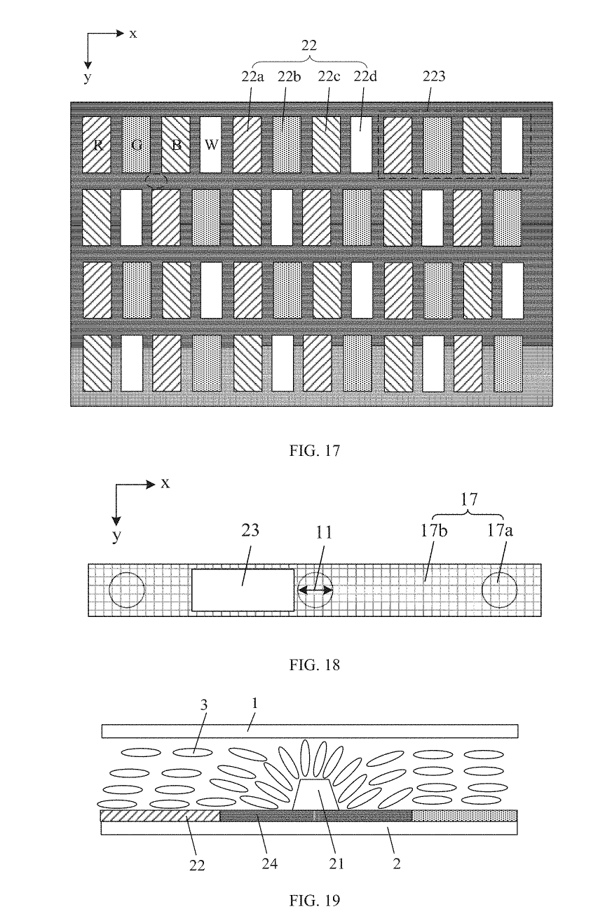

In one embodiment, as shown in FIG. 17, FIG. 17 is top view V of a second substrate according to an embodiment of the present disclosure. The color resistances 22 include pixel units 223. Each pixel unit 223 includes a first color resistance 22a, a second color resistance 22h, a third color resistance 22c, and a highlight color resistance 22d arranged along the row direction x of the sub-pixels. In one embodiment, adjacent rows of pixel units 223 may be repetitively arranged or may be arranged in a staggered manner along the row direction x of the sub-pixels, which will not be limited in the embodiments of the present disclosure, and selections may be made according to actual needs. Exemplarily, adjacent rows of pixel units 223 in FIG. 17 are arranged in such a manner that it is staggered with two color resistances 22 along the row direction x of the sub-pixels.

In one embodiment, in an embodiment of the present disclosure, as shown in FIG. 17, the areas of the first color resistance 22a, the second color resistance 22b, and the third color resistance 22c are the identical to each other, the area of the highlight color resistance 22d is smaller than the area of the first color resistance 22a, so that it is achieved that the areas of the first color resistance 22a, the second color resistance 22b, and the third color resistance 22c are the same on the entire second substrate 2, the brightness of the display panel will not be extremely high, and the display panel has a good display effect. In one embodiment, the area of the highlight color resistance is 50%-60% of the area of the first color resistance, so that the brightness of the display panel is relatively reasonable, which is suitable for outdoor highlight applications. Similarly, the first, second, and third color resistances may each be one of a red color resistance, a green color resistance, and a blue color resistance, and the highlight color resistance may be a yellow color resistance or a white color resistance. Exemplarily, as shown in FIG. 17, the first color resistance 22a is a red color resistance (shown as R in FIG. 17), the second color resistance 22b is a green color resistance (shown as G in FIG. 17), the third color resistance 22c is a blue color resistance (shown as B in FIG. 17), and the highlight color resistance 22d is a white color resistance (shown as W in FIG. 17).

In addition, as shown in FIG. 17, the area of the highlight color resistance 22d is smaller than the area of any one of the first color resistance 22a, the second color resistance 22b, and the third color resistance 22c, so that the edges of the color resistances may not be completely aligned during the arrangement. Taking the first to third color resistances in the first row and the first to third color resistances in the second row in FIG. 17 as an example, compared to the edge of the third color resistance in the first row, the edge of the third color resistance in the second row is closer to the left side. When the main spacer is provided at the elliptical region surrounded by the dotted line in FIG. 17, if the main spacer still adopts the arrangement in the related art, the spacer easily slides down into the aperture region of the first substrate 1. Therefore, as for the second substrate 2 having this structure, the arrangement of the first protrusion 12 in the embodiments of the present disclosure will have more significant beneficial effects.

In addition, in an embodiment of the present disclosure. In one embodiment, as shown in FIG. 3 and FIG. 4, auxiliary spacers 23 are further disposed on a side of the second substrate 2 facing the first substrate 1, and the height of the auxiliary spacer 23 is smaller than that of the main spacer 21, so that the auxiliary spacer 23 does not come in contact with the first substrate 1 when there is no pressing or there is light pressing; and when the pressing is relatively strong, the auxiliary spacer 23 comes into contact with the first substrate 1 to play a supporting role, and thus being able to better maintaining the box thickness of the display panel. In one embodiment, the auxiliary spacer 23 and the main spacer 21 are simultaneously formed so as to simplify the manufacturing process of the display panel and to reduce the manufacturing cost of the display panel. The height difference between the two can be achieved by a halftone process.

On this Basis, in an embodiment of the present disclosure, as shown in FIG. 2 and FIG. 4, second protrusions 17 is further disposed on a side of the insulating layer 10 facing the second substrate 2 at positions corresponding to the auxiliary spacers 23. Each protrusion 17 includes a second filling portion 17a filled in the at least one hole 11, and a second covering portion 17b connected to the second filling portion 17a. In the plane where the first substrate 1 is located, the auxiliary spacer 23 corresponds to the second protrusion 17, so that in the direction parallel to the plane where the first substrate 1 is located, when the first substrate 1 and the second substrate 2 are displaced relative to each other, the auxiliary spacer 23 can still be contact with the second protrusion 17 and will not slide into the aperture region of the first substrate 1.

In one embodiment, as shown in FIG. 2, FIG. 3 and FIG. 4, in the embodiments of the present disclosure, the first substrate 1 includes sub-pixels 18 arranged in an array, the second substrate 2 includes color resistances 22 arranged in an array, and the plurality of sub-pixels 18 corresponds to the plurality of color resistances 22 in one-to-one correspondence, and the extending direction of the second protrusion 17 is the row direction x of the sub-pixels 18.

Similarly, an end of the auxiliary spacer 23 facing the first substrate 1 pray choose a variety of shapes, for example, a rectangle, a square, a circle, or the like. In one embodiment, as shown in FIG. 3 and FIG. 18, FIG. 18 is a schematic diagram of a position relationship between a second protrusion and an auxiliary spacer according to an embodiment of the present disclosure. In the plane where the first substrate 1 is located, the vertical projection of the end of the auxiliary spacer 23 facing the first substrate 1 is rectangle-shaped, and an extending direction of its long edge is the same as the extending direction of the second protrusion 17, and the extending length of its length edge is smaller than the extending length of the second protrusion 17, so that the shape of the end of the auxiliary spacer 23 facing the first substrate 1 matches the shape of the second protrusion 17, the contact area of the auxiliary spacer 23 with the second protrusion 17 is relatively large, and the maintaining effect of the auxiliary spacer 23 with respect to the box thickness is better.

The second protrusion 17 can be formed simultaneously with the first protrusion 12 so as to simplify the manufacturing process of the display panel and to reduce the manufacturing cost of the display panel.

In order to facilitate the manufacturing of the first protrusion 12 and reduce the cost, In one embodiment, in an embodiment of the present disclosure, the material of the first protrusion 12 is identical to the material of the insulating layer 10, or the material of the first protrusion 12 is identical to the material of the main spacer 21, such as an organic photosensitive resin, etc. Similarly, the material of the second protrusion 17 is identical to the material of the insulating layer 10, or the material of the second protrusion 17 is identical to the material of the main spacer 21.

In one embodiment, as shown in FIG. 3, a grid-like black matrix 24 is arranged on the second substrate 2. The black matrix 24 defines aperture regions. The main spacer 21 is located on the black matrix 24. As shown in FIG. 3, each color resistance 22 is arranged in the aperture region defined by the black matrix 24. The arrangement of the black matrix 24 can be used to shield the light leakage. In an embodiment of the present disclosure, since the first protrusion 12 and the second protrusion 17 are arranged on the first substrate 1, the main spacer 21 and the auxiliary spacer 23 do not easily enter the aperture region of the first substrate 1, and there is little possibility to appear light leakage caused by the sliding of the main spacer 21 and the auxiliary spacer 23. Therefore, it is all right as long as the black matrix 24 covers the light leakage caused by the liquid crystal disorder around the main spacer 21 and the auxiliary spacer 23. Exemplarily, as shown in FIG. 19, FIG. 19 is a schematic diagram of a main spacer and a liquid crystal arrangement according to an embodiment of the present disclosure. When the display panel displays a black picture, the liquid crystal long axis direction at the corresponding position of the color resistance 22 is parallel with the plane where the second substrate 2 is located, and no light is emitted from the second substrate 2. Meanwhile, the liquid crystal long axis direction nearby the main spacer 21 forms an angle with respect to the plane where the second substrate 2 is located, resulting in that a part of the light is emitted from the vicinity of the main spacer 21 and gets out of the second substrate 2 to cause light leakage. Therefore, compared to the related art, the size of the black matrix 24 can be smaller, and then it can meet the requirement of shielding light leakage. Exemplarily, in an embodiment of the present disclosure, in the plane where the aperture region is located, the distance between an edge of the vertical projection of the end of the main spacer 21 located on the second substrate 2 and the aperture region is less than 3 μm, which helps to enhance the aperture ratio of the display panel. In one embodiment, the distance between the edge of the vertical projection of the end of the main spacer 21 located on the second substrate 2 and the aperture region is 2-3 μm, for example, 2.2 μm, 3 μm, 2.6 μm, and so on. Similarly, in the plane where the aperture region is located, the distance between the edge of the vertical projection of the end of the auxiliary spacer 23 located on the second substrate 2 and the aperture region may also be less than 3 μm, or in another embodiment may be 2-3 μm, for example, 2.3 μm, 2.4 μm, 2.5 μm, 2.8 μm and so on.

It should be noted that, the fewer the number of holes 11 corresponding to the first protrusions 12 and the second protrusions 17, the greater the density of the spacers (including the main spacers 21 and the auxiliary spacers 23), and the better the maintaining effect with respect to box thickness, but it will have a certain influence on the liquid crystal injection in the display panel. The number of holes 11 corresponding to the first protrusions 12 and the second protrusions 17 in the embodiments of the present disclosure can be selected according to actual requirements. In one embodiment, as shown in FIG. 2, in an embodiment of the present disclosure, the first protrusion 12 corresponds to two holes 11, and the second protrusion 17 corresponds to three holes 11.

If the first substrate 1 includes other holes 11 besides the holes 11 corresponding to the first protrusions 12 and the second protrusions 17, the first substrate 1 may further include a filling structure for filling the other holes 11, so that the entire first substrate 1 is flattened, decreasing the thus formed liquid crystal disorder, thereby helping to improve the display effect of the display panel.

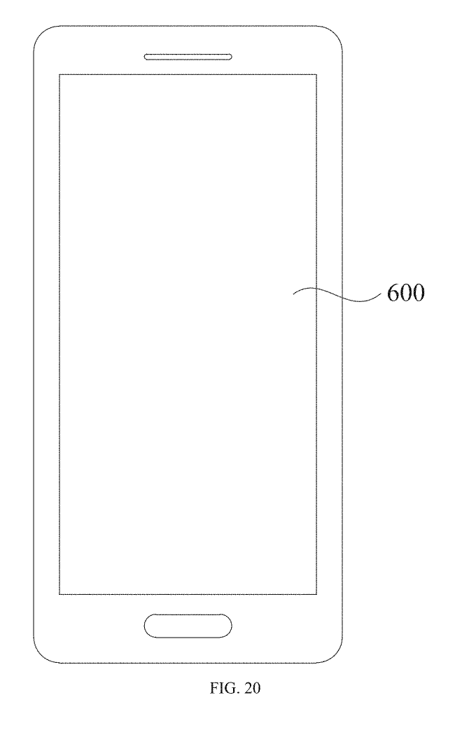

In addition, the present disclosure further provides a display device. As shown in FIG. 20, FIG. 20 is a schematic diagram of a display device according to an embodiment of the present disclosure. The display device includes any one of the display panels 600 described above. The display device may be any product or component that has a display function, such as a smart phone, a wearable smart watch, a pair of smart glasses, a tablet computer, a television, a monitor, a notebook computer, a digital photo frame, a navigator, an on-board monitor, an e-book, or the like.

In the display panel and display device described above, main spacers are provided on the second substrate, and first protrusions are provided on a side of the insulating layer in the first substrate facing the second substrate, and an end of the main spacer is in contact with the first protrusion. The first protrusions each include first filling portions filled in at least two holes and a first covering portion connected to the first filling portions, in the plane where the first substrate is located, an arrangement direction of vertical projections of the first filling portions intersects with an extending direction of a vertical projection of the first covering portion, so that the area of the first protrusion is relatively large, and the contact area of the main spacer with the first protrusion is relatively large, in a direction parallel to the first substrate (for example, the arrangement direction of the vertical projections of the first filling portions, and the extending direction of the vertical projection of the first covering portion), when the second substrate and the first substrate are relatively displaced, one end of the main spacer can still be contact with the first protrusion, and it is not easy to enter the aperture region, which can not only improve the maintaining effect of the main spacer with respect to the box thickness of the display panel, but also alleviate or even avoid the squeezing problem caused by the slipping of main spacer.

Finally, it should be noted that, the above-described embodiments are merely for illustrating the present disclosure but not intended to provide any limitation. Although the present disclosure has been described in detail with reference to the above-described embodiments, it should be understood that, it is still possible to modify the technical solutions described in the above embodiments or to equivalently replace some or all of the technical features therein, but these modifications or replacements do not cause the essence of corresponding technical solutions to depart from the scope of the present disclosure.

What is claimed is:

1. A display panel, comprising:
a first substrate; and
a second substrate oppositely disposed with respect to each other,
wherein an insulating layer is disposed on a surface of the first substrate facing the second substrate, and the insulating layer has a plurality of holes therein, a plurality of main spacers are disposed on a surface of the second substrate facing the first substrate;
a plurality of first protrusions are further disposed at positions on a surface of the insulating layer facing the second substrate corresponding to the plurality of main spacers;
the plurality of first protrusions each comprises:
first filling portions filled in at least two of the plurality of holes and a first covering portion connected to the first filling portions;
in a plane where the substrate is located, an arrangement direction of a vertical projection of the first filling portions intersects with an extending direction of a vertical projection of the first covering portion, and an end of each of the plurality of main spacers is in contact with a respective one of the plurality of first protrusions.

2. The display panel according to claim 1, wherein the plurality of first protrusions each comprises:
two first filling portions filled in two of the plurality of holes; and
in the plane where the first substrate is located, an arrangement direction of vertical projections of the two first filling portions intersects with an extending direction of a vertical projection of the first covering portion.

3. The display panel according to claim 2, wherein the first substrate comprises:
a plurality of sub-pixels arranged in an array, the second substrate comprises a plurality of color resistances arranged in an array, and the plurality of sub-pixels corresponds to the plurality of color resistances in one-to-one correspondence; and in the plane where the first substrate is located, the arrangement direction of the vertical projections of the two first filling portions and the extending direction of the vertical projection of the first covering portion are respectively a row direction and a column direction of the plurality of sub-pixels.

4. The display panel according to claim 3, wherein in the plane where the first substrate is located, the arrangement direction of the vertical projections of the two first filling portions is the row direction of the plurality of sub-pixels, and the extending direction of the vertical projection of the first covering portion is the column direction of the plurality of sub-pixels.

5. The display panel according to claim 3, wherein in the plane where the first substrate is located, a vertical projection of an end of each of the plurality of main spacers in contact with a respective one of the plurality of first protrusions is in a shape of rectangle, and an extending direction of a long edge of the rectangle is the row direction or column direction of the plurality of sub-pixels.

6. The display panel according to claim 3, wherein the plurality of color resistances comprises a first color resistance, a second color resistance, a third color resistance, and a highlight color resistance.

7. The display panel according to claim 6, wherein the first color resistance is one of a red color resistance and a green color resistance, and the second color resistance is one of the red color resistance and the green color resistance which is different from the first color resistance, the third color resistance is a blue color resistance, and the highlight color resistance is a yellow color resistance or a white color resistance.

8. The display panel according to claim 7, wherein the plurality of color resistances comprises multiple first pixel units and multiple second pixel units, wherein the multiple first pixel units and the multiple second pixel units are alternately arranged along the column direction of the plurality of sub-pixels, the multiple first pixel units each comprises the first color resistance, the second color resistance, and the third color resistance arranged in sequence along the row direction of the plurality of sub-pixels, the multiple second pixel units each comprises a first color resistance, a second color resistance, and a highlight color resistance arranged in sequence along the row direction of the plurality of sub-pixels, an area of the third color resistance is larger than an area of the first color resistance, and an area of the highlight color resistance is smaller than a sum of areas of two first color resistances.

9. The display panel according to claim 8, wherein the area of the third color resistance is twice the area of the first color resistance, and the area of the highlight color resistance is 50%-60% of the sum of areas of two first color resistances.

10. The display panel according to claim 8, wherein in a plane where the plurality of color resistance is located, a vertical projection of each of the plurality of main spacers are located among adjacent two first color resistances and two second color resistances.

11. The display panel according to claim 7, wherein the plurality of color resistances comprises multiple pixel units, and the multiple pixel units each comprises the first color resistance, the second color resistance, the third color resistance, and the highlight color resistance arranged along the row direction of the plurality of sub-pixels.

12. The display panel according to claim 11, wherein the first color resistance, the second color resistance, and the third color resistance have an identical area, and the highlight color resistance has an area smaller than the area of the first color resistance.

13. The display panel according to claim 12, wherein the area of the highlight color resistance is 50%-60% of the area of the first color resistance.

14. The display panel according to claim 1, wherein a plurality of auxiliary spacers are further disposed on the surface of the second substrate facing the first substrate, and a height of each of the plurality of auxiliary spacers is smaller than a height of a respective one of the plurality of main spacers, a plurality of second protrusions is further disposed at positions on one surface of the insulating layer facing the second substrate corresponding to the plurality of auxiliary spacers, the plurality of second protrusions each comprises second filling portions filled in at least two of the plurality of holes and a second covering portion connected to the second filling portions, and in the plane where the first substrate is located, the plurality of auxiliary spacers corresponds to the plurality of second protrusions.

15. The display panel according to claim 14, wherein the first substrate comprises a plurality of sub-pixels arranged in an array, the second substrate comprises a plurality of color resistances arranged in an array, the plurality of sub-pixels corresponds to the plurality of color resistances in one-to-one correspondence, and an extending direction of each of the plurality of second protrusion is the row direction of the plurality of sub-pixels.

16. The display panel according to claim 15, wherein in the plane where the first substrate is located, a vertical projection of an end of each of the plurality of auxiliary spacers facing the first substrate is in a shape of rectangle, and an extending direction of a long edge of the rectangle is the same as the extending direction of a respective one of the plurality of second protrusions, and an extending length of the long edge of the rectangle is smaller than the extending length of a respective one of the plurality of second protrusions.

17. The display panel according to claim 1, wherein the plurality of first protrusions and the insulating layer are made of a same material.

18. The display panel according to claim 1, wherein the plurality of first protrusion and the plurality of main spacers are made of a same material.

19. The display panel according to claim 1, wherein a grid-shaped black matrix is arranged on the second substrate and defines a plurality of aperture regions, the plurality of main spacers is located on the black matrix, and in the plane where the plurality of aperture regions is located, a distance between an edge of the vertical projection of an end of each of the plurality of main spacers located on the second substrate and a respective one of the plurality of aperture regions is less than 3 μm.

20. A display device, comprising:
a display panel, wherein the display panel comprises:
a first substrate and a second substrate oppositely disposed with respect to each other, wherein an insulating layer is disposed on a surface of the first substrate facing the second substrate, and the insulating layer has a plurality of holes therein, a plurality of main spacers are disposed on a surface of the second substrate facing the first substrate;
a plurality of first protrusions are further disposed at positions on a surface of the insulating layer facing the second substrate corresponding to the plurality of main spacers;
the plurality of first protrusions each comprises first filling portions filled in at least two of the plurality of holes and a first covering portion connected to the first filling portions, in a plane where the substrate is located, an arrangement direction of a vertical projection of the first filling portions intersects with an extending direction of a vertical projection of the first covering portion, and an end of each of the plurality of main spacers is in contact with a respective one of the plurality of first protrusions.
